(19) United States
(12) Patent Application Publication
(10) Pub. No.: US 2025/0097661 A1
(43) Pub. Date: Mar. 20, 2025

(54) Three-Dimensional, Direction-Dependent Audio for Multi-Entity Telecommunication

(71) Applicant: Google LLC, Mountain View, CA (US)

(72) Inventor: Shahabuddin Kakargola, Costa Mesa, CA (US)

(73) Assignee: Google LLC, Mountain View, CA (US)

(21) Appl. No.: 18/577,068

(22) PCT Filed: Jul. 13, 2022
(86) PCT No.: PCT/US2022/073667

§ 371 Date: Jan. 5, 2024

(51) Int. Cl. H04S 7/00; G06F 3/16; H04L 65/1083; H04L 65/403; H04L 65/75

(52) U.S. Cl. CPC H04S 7/306; G06F 3/165; G06F 3/167; H04L 65/1083; H04L 65/403; H04L 65/764; H04S 2400/11; H04S 2420/01

(57) ABSTRACT

The document describes systems and techniques directed at three-dimensional, direction-dependent audio for multi-entity telecommunication. In aspects, a remote device receives multi-stream content, including at least one audio stream, from one or more audio-producing entities and obtains orientation information associated with the one or more audio-producing entities. The remote device can then, using the at least one audio stream and the orientation information, provide direction-dependent, three-dimensional audio sufficient to enable a multi-stereo audio output device to reproduce the spatial audio as if the at least one audio stream is originating from a direction, an elevation, and/or a proximity that corresponds to a physical location of the one or more audio-producing entities.

### BACKGROUND

Technological advances in the field of telecommunications have promoted worldwide interconnectivity, fostering information exchange, as well as foreign and domestic cooperation. In one particular aspect, these technological advances have led to an improvement in the size, quality, and type of content of data transmitted using digital telecommunications. For instance, the development of metal-oxide-semiconductor (MOS) large-scale integration (LSI) technology, information technology, and cellular networking, largely in the mid-to-late twentieth century, resulted in the construction of affordable portable wireless communication devices, empowering users to transmit and exchange large amounts of data while mobile. These developments have provided a great deal of conveniences and luxuries to the lives of users.

These technological advances have yet to replicate the full authenticity of face-to-face communication, however. Further, some segments of the world's population struggle with the complexity associated with devices that utilize such technological advances, including how to operate, maintain, and/or navigate interfaces associated with these devices. Thus, to further promote worldwide interconnectivity, it is desirable to resolve such shortcomings.

### SUMMARY

The document describes systems and techniques directed at three-dimensional, direction-dependent audio for multi-entity telecommunication. In aspects, a remote device receives multi-stream content, including at least one audio stream, from one or more audio-producing entities and obtains orientation information associated with the one or more audio-producing entities. The remote device can then, using the at least one audio stream and the orientation information, provide direction-dependent, three-dimensional audio sufficient to enable a multi-stereo audio output device to reproduce the spatial audio as if the at least one audio stream is originating from a direction, an elevation, and/or a proximity that corresponds to a physical location of the one or more audio-producing entities.

In aspects, a method is disclosed that includes: receiving, at a remote device and during an active, multi-entity audio communication: first audio information associated with a first audio-producing entity of multiple entities of the multi-entity audio communication; and second audio information associated with a second audio-producing entity of the multiple entities of the multi-entity audio communication: obtaining orientation information associated with at least one of the first audio-producing entity, the second audio-producing entity, or the remote device indicative of a relative positioning of at least one of the first audio-producing entity or the second audio-producing entity with respect to the remote device, the orientation information usable to determine: a first direction between the first audio-producing entity and an audio-receiving entity; and a second direction between the second audio-producing entity and the audio-receiving entity; and providing three-dimensional, direction-dependent audio information, the three-dimensional, direction-dependent audio information sufficient to enable a multi-stereo audio output device associated with the audio-receiving entity to reproduce direction-dependent, three-dimensional audio.

The method may also include obtaining orientation information associated with the audio-receiving entity. In aspects, the audio-receiving entity may be an electronic device, a hearable device, the remote device, and/or a server.

Implementations may include one or more of the following features or examples, or any combination thereof. In an example, the remote device is the multi-stereo audio output device. In another example, the multi-stereo audio output device, using the three-dimensional, direction-dependent audio information, is configured to reproduce direction-dependent, three-dimensional audio that includes an audible-manipulation of at least one of the first audio information or the second audio information based on the orientation information of one or more of the multi-stereo audio output device, the first audio-producing device, and the second audio-producing device. In another example, the audible-manipulation includes a machine-learned technique configured to adjust at least one of an inter-aural time difference, an inter-aural level difference, or a timbre difference.

In a further example, the multi-stereo audio output device includes one or more of a smartphone, wireless earbuds, and wired headphones. In another example, the remote device is a computing entity associated with a communication network through which the active, multi-entity audio communication is enabled. In another example, the method further comprising determining, based on a capability or configuration of the multi-stereo audio output device, that the receiving entity is not capable of providing three-dimensional, direction-dependent audio information, and, responsive to the determining, performing operations of determining and providing at the computing entity. In another example, receiving multi-entity audio communication and obtaining orientation information occur in real-time and concurrently.

In an additional example, the first audio information and orientation information associated with the first audio-producing entity are transmitted together in multi-stream data from the first audio-producing entity. In another example, obtaining orientation information associated with at least the first audio-producing entity, the second audio-producing entity, or the remote device comprises acquiring location information associated therewith based on a location-based application. In another example, the orientation information is further usable to determine: a first rotation of the first audio-producing entity with respect to a relative rotation of the remote device; and a second rotation of the second audio-producing entity with respect to the relative rotation of the remote device. In another example, the first rotation or the second rotation of the first audio-producing entity or the second audio-producing entity, respectively, with respect to the relative rotation of the remote device is further usable to determine one or more of a difference in elevation and a proximity between the first audio-producing entity and the remote device or the second audio-producing entity and the remote device.

In a still further example, the orientation information includes an orientation of a user's head or ears or an orientation of one or more speakers or exterior housing of the first audio-producing entity, the second audio-producing, or the remote device. In an example the method further comprising receiving video information, and wherein providing the three-dimensional, direction-dependent audio provides video information enabling a display associated with the multi-stereo audio output device to provide video associated with the first or second audio-producing entity. In an example determining the first and second directions further determines first and second vectors, the first and second vectors having the first and second directions, respectively, the first and second vectors having respective magnitudes based on an absolute or relative distance between the audio-receiving entity and first and second locations of the location information, and wherein the providing the three-dimensional audio provides three-dimensional audio with corresponding magnitudes.

This document also describes computer-readable media having instructions for performing the above-summarized methods and other methods set forth herein, as well as systems and means for performing these methods.

The details of one or more implementations are set forth in the accompanying Drawings and the following Detailed Description. Other features and advantages will be apparent from the Detailed Description, the Drawings, and the Claims.

### BRIEF DESCRIPTION OF DRAWINGS

The details of one or more aspects for three-dimensional, direction-dependent audio for multi-entity telecommunication are described in this document with reference to the following Drawings, in which the use of same numbers in different instances may indicate similar features or components:

FIG. 1-1 is an illustration of an example environment in which techniques enabling and apparatuses configured for telecommunications may be embodied:

FIG. 1-2 is an illustration of a user speaking an audio message to another user via their electronic device:

FIG. 1-3 is an illustration of an example environment in which techniques enabling and apparatuses configured for three-dimensional, direction-dependent audio for multi-entity telecommunication may be embodied;

FIG. 2 illustrates example electronic devices capable of reproducing audio messages with spatial audio:

FIG. 3 illustrates an example operating environment including example external devices capable of connecting to electronic devices and having one or more interface mechanisms:

FIG. 4 illustrates an example implementation of a spatial audio manager, referred to in FIGS. 2 and 3, in more detail:

FIG. 5 illustrates three example implementations in which three-dimensional, direction-dependent audio for multi-entity telecommunication can be implemented:

FIG. 6 illustrates an example implementation including three electronic devices, network(s), and a server system configured to implement three-dimensional, direction-dependent audio for multi-entity telecommunication:

FIG. 7 is an illustration of an example environment in which techniques enabling and apparatuses configured for telecommunications may be embodied:

FIG. 8 illustrates an example technique by which a spatial audio manager may manipulate an audio message to include a spatial audio effect; and

FIG. 9 illustrates an example method in accordance with one or more aspects of three-dimensional, direction-dependent audio for multi-entity telecommunication.

### DETAILED DESCRIPTION

### Overview

Technological advances in the field of telecommunications (e.g., multi-entity audio communication) have promoted worldwide interconnectivity, fostering information exchange, as well as foreign and domestic cooperation. Telecommunications, such as voice chat and videotelephony, provide users many conveniences, including long-distance communication, but may also include shortcomings.

In one example, two or more users of portable wireless communication devices may attempt to locate each other at a park, such as a national park. The two or more users provide numerous visual (e.g., at the base of the mountain, at the tall tree) or relational (e.g., near the lake, near the hiking path) cues in an attempt to communicate their geographic location. Depending on a number of factors, including the number of participants, the size of the park, the number of people at the park, the time of day, and the quality of the visual or relational cues, geographically locating another user can prove to be difficult.

In another example, two users of portable wireless communication devices may be speaking to each other under various circumstances. For instance, a first user may be in a restaurant while a second user is out walking. While the first user is speaking to the second user, the first user may be approached by a waiter who is ready to take their order. The second user, being unaware of the first speaker's context, may interpret a message spoken by the first user to the waiter as applying to himself, such as a request for coffee and a sandwich.

In both of these examples, text messages, voice messages, and, even, video messages may provide insufficient information to one or more users participating in a given form of telecommunication to facilitate effective communication (e.g., information transmittal). To this end, this document describes systems and techniques directed at three-dimensional, direction-dependent audio for multi-entity telecommunication. In aspects, a remote device receives multi-stream content, including at least one audio stream, from one or more audio-producing entities. The remote device further obtains contextual data, including orientation information, associated with the one or more audio-producing entities and/or users of the one or more audio-producing entities. The remote device can then, using the audio stream and the orientation information, provide direction-dependent, three-dimensional audio sufficient to enable a multi-stereo audio output device to reproduce the spatial audio as if the audio stream is originating from a direction, an elevation, and/or a proximity that corresponds to a geographic location of the audio-producing entity.

The following discussion describes operating environments and techniques that may be employed in the operating environments and example methods. Although systems and techniques for three-dimensional, direction-dependent audio for multi-entity telecommunication are described, it is to be understood that the subject of the appended Claims is not necessarily limited to the specific features or methods described. Rather, the specific features and methods are disclosed as example implementations and reference is made to the operating environment by way of example only.

### Example Environment

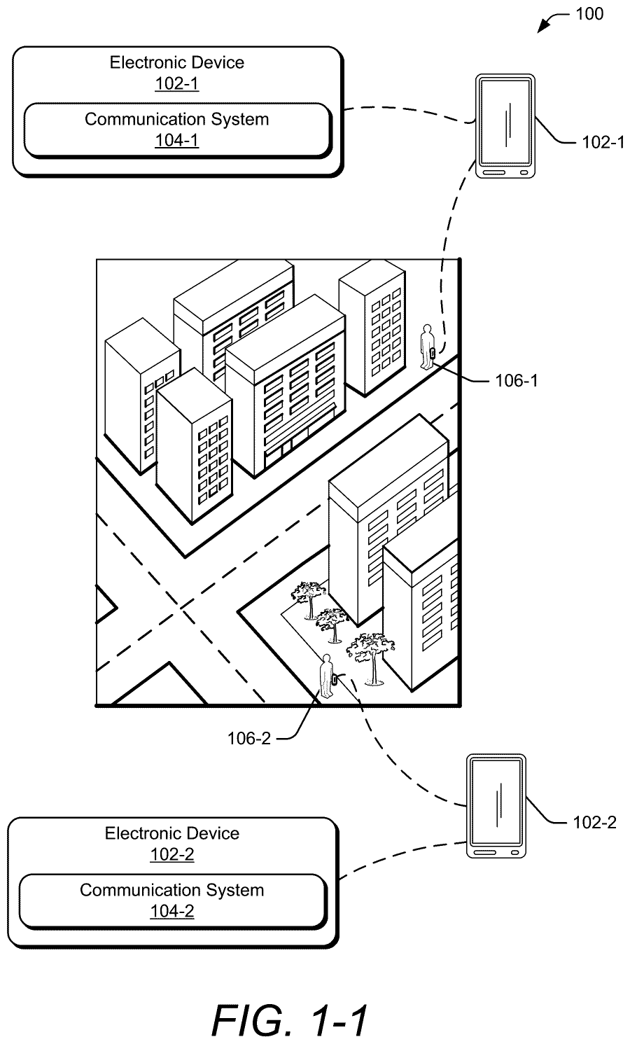

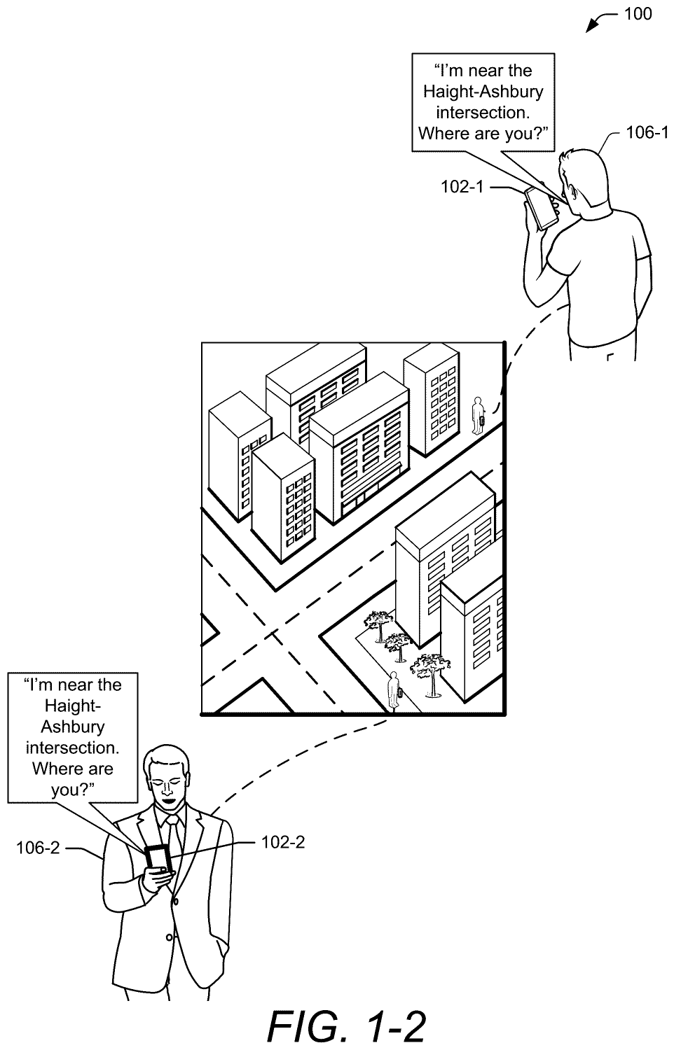

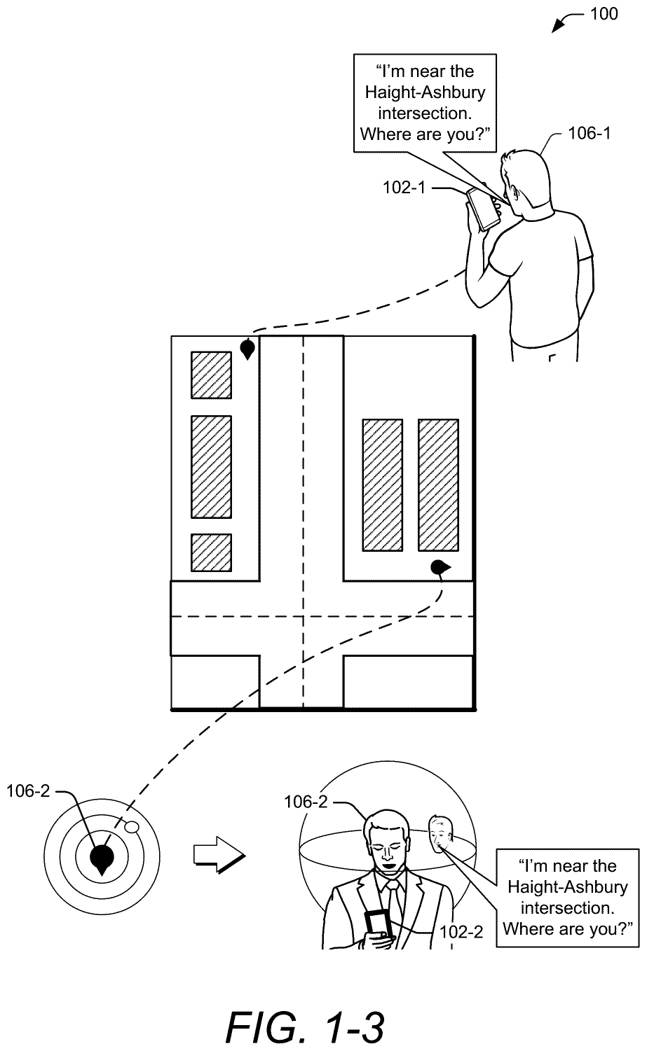

FIG. 1-1 is an illustration of an example environment 100 in which techniques enabling and apparatuses configured for telecommunications may be embodied. Environment 100 illustrates two example electronic devices 102 (e.g., electronic device 102-1, electronic device 102-2), each having a communication system 104 (e.g., communication system 104-1, communication system 104-2) configured to provide inter-device telecommunication. Two users 106 (e.g., user 106-1, user 106-2) may communicate (e.g., speak) to each other in substantially real-time via the communication system 104 of their respective electronic device 102.

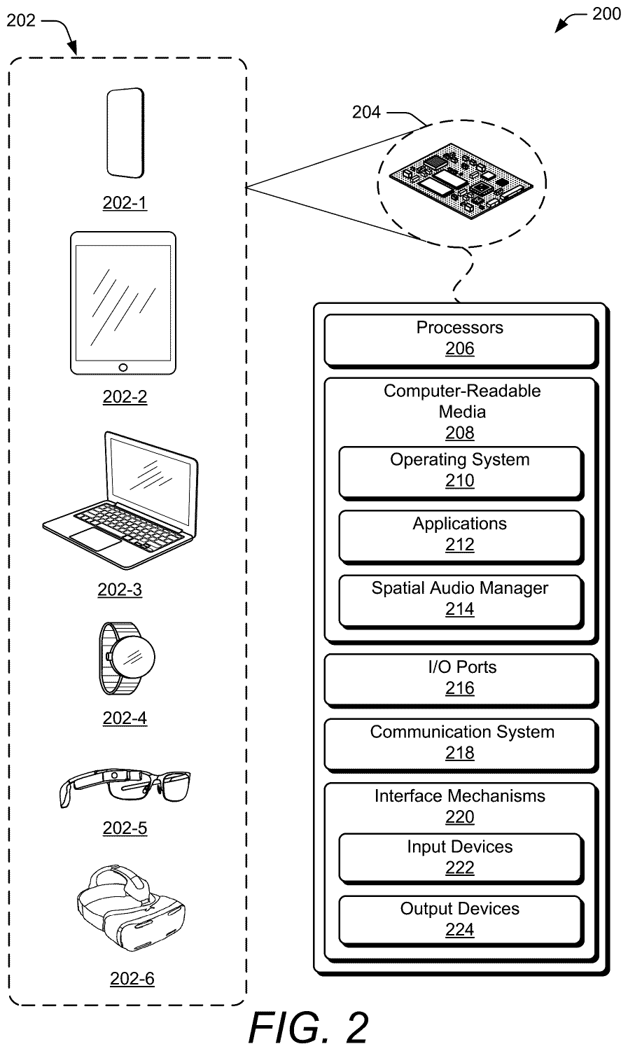

For example, as illustrated in FIG. 1-2, the user 106-1 speaks an audio message to the user 106-2 by speaking to their electronic device 102-1. In more detail, after receiving the audio message, the electronic device 102-1 can transmit the audio message, via its respective communication system 104-1, to the communication system 104-2 of the electronic device 102-2. The electronic device 102-2 can then audibly reproduce the audio message such that the user 106-2 can hear the user 106-1 speaking.

In many scenarios, when two or more users are attempting to geographically locate each other, it can be difficult to locate another user based solely on a meaning of words in an audio message. For instance, as illustrated in FIG. 1-2, the user 106-1 states that he is near the Haight-Ashbury intersection in order to convey their geographic location to the user 106-2. Yet, the words of the audio message alone may be insufficient to quickly convey a proximate geographic location of the user 106-1 to the user 106-2. In fact, additional information that may be associated with the speech of the user 106-1 that could be used by the user 106-2 to facilitate locating the user 106-1 may be lost (e.g., not used) during the acquisition, transmission, and/or reproduction of the audio message.

As an example, humans have two ears, which receive and transduce mechanical pressure waves (e.g., sound) that propagate through air. The ear can be divided into two regions: the outer ear and the inner ear. The outer ear, referred to as the auricle (e.g., the pinna) collects sound, manipulates (e.g., transforms, delays) at least some of the collected sound thereby adding information (e.g., directional information) to the collected sound, and directs the collected sound into the inner ear (e.g., the auditory canal). In more detail, an auricle can manipulate the collected sound using a helix, antihelix, or concha based on a source location of the collected sound relative to the auricle. This sound manipulation by the various regions of the auricle enables directional hearing. The inner ear can then transduce the collected sound into electrical impulses so the brain can interpret the electrical impulses to recognize sounds. The field of study focusing on this phenomenon is referred to as psychoacoustics.

Due to the manipulation and the resultant interpretation of the collected sound, the brain can not only interpret sound, for example, to determine words, but it can also subconsciously extract additional information to intuit a direction (e.g., directional hearing) and/or a magnitude of the sound. In telecommunications, this additional information may be lost, or partly lost, during the acquisition, transmission, and/or reproduction of an audio message by an electronic device and, thus, the additional information may be undetectable by a receiving user.

Due to the lack of additional information in the audio message, the user 106-2 may have some difficulty geographically locating the user 106-1. Whereas, if, for example, the user 106-1 were to shout the audio message such that the user 106-2 could hear the audio message without the aid of the electronic devices 102, then the user 106-2 may be able to more quickly determine a direction and discover a proximate geographic location of the user 106-1.

FIG. 1-3 is an illustration of an example environment 100 in which techniques enabling and apparatuses configured for three-dimensional, direction-dependent audio for multi-entity telecommunication may be embodied. As illustrated, the electronic device 102-2 may be configured to reproduce the audio message of the user 106-1 in such a fashion that the user 106-2 can intuit additional information useful for geographically locating the user 106-1 more quickly. Such additional information included in the audio message may enable the user 106-2 to, as non-limiting examples, determine a direction of the user 106-1 relative to a nose-facing orientation (e.g., a yaw of a face) of the user 106-2, an elevation of the user 106-1 relative to a pitch and/or a roll of a head of the user 106-2, and/or a proximity of the user 106-1 relative to the user 106-2 based on a volume of the audio message (e.g., an increase in volume, a decrease in volume). As described herein, an electronic device reproducing the audio message that positions an audio message in three-dimensional space, which may enable the user to intuit additional information useful in geographically locating another user, is referred to herein as reproducing an audio message with spatial audio (e.g., direction-dependent audio).

Example electronic devices capable of reproducing audio messages with spatial audio are shown in more detail in FIG. 2. As illustrated, an example operating environment 200 includes an example electronic device 202 (e.g., electronic device 102-1), which is capable of implementing three-dimensional, direction-dependent audio for multi-entity telecommunication in accordance with one or more implementations. Examples of an electronic device 202 include a smartphone 202-1, a tablet 202-2, a laptop 202-3, a smartwatch 202-4, smart-glasses 202-5, and virtual-reality (VR) goggles 202-6. Although not shown, the electronic device 202 may also be implemented as any of a mobile station (e.g., fixed- or mobile-STA), a mobile communication device, a client device, a home automation and control system, an entertainment system, a gaming console, a personal media device, a health monitoring device, a drone, a camera, an Internet home appliance capable of wireless Internet access and browsing, an IoT device, security systems, and the like. Note that the electronic device 202 can be wearable, non-wearable but mobile, or relatively immobile (e.g., desktops, appliances). Further, the electronic device 202, in implementations, may be an implanted device (e.g., devices that are embedded in the human body), including radiofrequency identification (RFID) microchips, near-field communication (NFC) microchips, and so forth. Note also that the electronic device 202 can be used with, or embedded within, electronic devices or peripherals, such as in automobiles (e.g., steering wheels) or as an attachment to a laptop computer. In additional implementations, the electronic device 202 may include fewer and/or different components, or different arrangements of components than those illustrated in FIG. 2 and described herein. In still further implementations, the electronic device 202 may include components or interfaces omitted from FIG. 2 for the sake of clarity or visual brevity.

For example, although not shown, the electronic device 202 can also include a system bus, interconnect, crossbar, or data transfer system that couples the various components within the device. A system bus or interconnect can include any one or combination of different bus structures, such as a memory bus or memory controller, a peripheral bus, a universal serial bus, and/or a processor or local bus that utilizes any of a variety of bus architectures. In another example, the electronic device may further include a power supply. In implementations, the power supply includes any combination of electrical circuitry (e.g., wires, traces) and electrical components (e.g., capacitors, inductors) associated with distributing and providing electrical power to the electronic device 202 and components therein. In an implementation, the power supply includes a battery pack configured to store and supply electrical energy, as well as wires configured to distribute the electrical energy to electrical components within the electronic device 202. In other implementations, for example, the power supply includes wiring and a USB I/O port configured to receive electrical energy from an external source and supply it to electrical components of the electronic device 202.

As illustrated, the electronic device 202 includes a printed circuit board assembly 204 (PCBA 204) on which components and interconnects of the electronic device 202 are embodied. Alternatively or additionally, components of the electronic device 202 can be embodied on other substrates, such as flexible circuit material or other insulative material. The electronic device 202 may also include a frame defining a housing having an internal cavity. The housing may include an exterior surface and an opposing interior surface. The exterior surface may include at least one portion in contact with a physical medium (e.g., hair, skin, tissue, clothing) associated with a user. For example, a smartwatch 202-4 can include an exterior surface in contact with a wrist of a user. In aspects, the housing may be any of a variety of plastics, metals, acrylics, or glasses. In an implementation, the exterior surface of the housing includes one or more channels (e.g., holes). In some implementations, the housing includes a display implemented as an electroluminescent display (ELD), an active-matrix organic light-emitting diode display (AMOLED), a liquid crystal display (LCD), or the such. Although not illustrated, various other electronic components or devices can be housed in the internal cavity of the electronic device 202. Generally, electrical components and electromechanical components of the electronic device 202 are assembled onto a printed circuit board (PCB) to form the PCBA 204. Various components of the PCBA 204 (e.g., processors and memories) are then programmed and tested to verify the correct function of the PCBA 204. The PCBA 204 is connected to or assembled with other parts of the electronic device 202 into a housing.

As illustrated, the PCBA 204 includes one or more processors 206 and computer-readable media 208. The processors 206 may include any suitable single-core or multi-core processor (e.g., an application processor (AP), a digital-signal processor (DSP), a central processing unit (CPU), graphics processing unit (GPU)). The processors 206 may be configured to execute instructions or commands stored within computer-readable media 208. The computer-readable media 208 can include an operating system 210, one or more applications 212, and a spatial audio manager 214. In at least some implementations, the operating system 210 and/or the one or more applications 212, implemented as computer-readable instructions on the computer-readable media 208, can be executed by the processors 206 to provide some or all of the functionalities described herein, such as some or all of the functions of the spatial audio manager 214 (shown within the computer-readable media 208, though this is not required). The computer-readable media 208 may include computer-readable storage media (not illustrated), including one or more non-transitory storage devices such as a random access memory (RAM, dynamic RAM (DRAM), non-volatile RAM (NVRAM), or static RAM (SRAM)), read-only memory (ROM), or flash memory), hard drive, solid-state drive (SSD), or any type of media suitable for storing electronic instructions, each coupled with a computer system bus. The term “coupled” may refer to two or more elements that are in direct contact (physically, electrically, magnetically, optically, etc.) or to two or more elements that are not in direct contact with each other, but still cooperate and/or interact with each other.

The computer-readable media 208 may also store device data in an on-device or off-device database (not illustrated). The device data may include telephone numbers, user data, account data, location data, sensor data (e.g., acceleration data, barometric pressure data), and so on. The spatial audio manager 214 may access and use the data stored in the database as described in greater detail below.

The operating system 210 and/or the one or more applications 212 may provide users with numerous operational modes, including a music playing mode, a camera mode, a telephonic mode, etc. Some of these modes can operate in parallel with other modes, such as the music playing mode with the camera mode.

The PCBA 204 may also include input/output (I/O) ports 216. The I/O ports 216 allow the electronic device 202 to interact with other devices, conveying any combination of digital signals, analog signals, and radiofrequency (RF) signals. The I/O ports 216 may include at least one of internal or external ports, such as universal serial bus (USB) ports, audio ports. Serial ATA (SATA) ports, peripheral component interconnect express (PCI-express) based ports or card-slots, secure digital input/output (SDIO) slots, and/or other legacy ports. Various devices may be operatively coupled with the I/O ports 216, such as human-input devices (HIDs), external computer-readable storage media, or other peripherals.

The PCBA 204 may further include a communication system 218 (e.g., communication system 104). The communication system 218 enables communication of device data, such as received data, transmitted data, or other information as described herein, and may provide connectivity to one or more networks and other devices connected therewith. Example communication systems include NFC transceivers. WPAN radios compliant with various IEEE 802.15 (Bluetooth®) standards. WLAN radios compliant with any of the various IEEE 802.11 (WiFi®) standards. WWAN (3GPP-compliant) radios for cellular telephony, wireless metropolitan area network (WMAN) radios compliant with various IEEE 802.16 (WiMAX®) standards, infrared (IR) transceivers compliant with an Infrared Data Association (IrDA) protocol, and wired local area network (LAN) Ethernet transceivers. Device data communicated over the communication system 218 may be packetized or framed depending on a communication protocol or standard by which the electronic device 202 is communicating. The communication system 218 may include wired interfaces, such as Ethernet or fiber-optic interfaces for communication over a local network, private network, intranet, or the Internet. Alternatively or additionally, the communication system 218 may include wireless interfaces that facilitate communication over wireless networks, such as wireless LANs, cellular networks, or WPANs.

The PCBA 204 may further include, or be operatively coupled to, one or more interface mechanisms 220. The one or more interface mechanisms 220 can be configured to receive and/or output data. For example, the one or more interface mechanisms 220 may include input devices 222 and/or output devices 224, or some combination thereof. In implementations, the input devices 222 (e.g., sensors) include, as non-limiting examples, an audio sensor (e.g., a microphone), a keypad (e.g., a standard telephone keypad, a QWERTY keypad), a touch-input sensor (e.g., a touchscreen), an image-capture device (e.g., a camera, video-camera), an elevation measurement device (e.g., a barometer), a global positioning system (GPS), a gyroscope, a compass, an accelerometer, proximity sensors (e.g., capacitive sensors), radar sensors, a magnetometer, and/or an ambient light sensor (e.g., photodetector). The input devices 222 are configured to receive, measure, and/or generate device data related to conditions, events, or qualities associated with (e.g., surrounding) an electronic device 202. In further implementations, the output devices 224 include, as non-limiting examples, one or more speakers (e.g., a multi-stereo audio output device), a display, haptic feedback mechanisms, and so on.

Although a GPS system is described as an example input device 222 used for positioning the electronic device 202, it should be noted that other positioning systems or techniques may be utilized to determine a location of the electronic device 202. For example, cellular positioning techniques, including triangulation may be utilized to determine a location of the electronic device 202. Further, local positioning techniques utilizing one or more of Bluetooth, IEEE 802.11. Ultra Wide Band, and so on can be used to determine a location of the electronic device 202. In still further implementations, a precise longitude or latitude of the electronic device 202 may not be relied upon to determine a proximate location. Instead, a proximate location may be determined based on a relative distance, elevation, etc. to another location.

In aspects, the one or more interface mechanisms 220 may be separate from, but connected to (e.g., via a wireless linking, via a wired link), the PCBA 204 and/or components thereon. For example, in some implementations, an interface mechanism 220 may be implemented as a peripheral device connected to the PCBA 204 via, for example, an I/O port 216. In still further implementations, one or more of the interface mechanisms 220 can be connected to components of the PCBA 204 (e.g., processors 206) via the communication system 218 (e.g., a wireless network, a pairing). In addition, one or more of these interface mechanisms 220 may be integrated into a single external device connected to the PCBA 204.

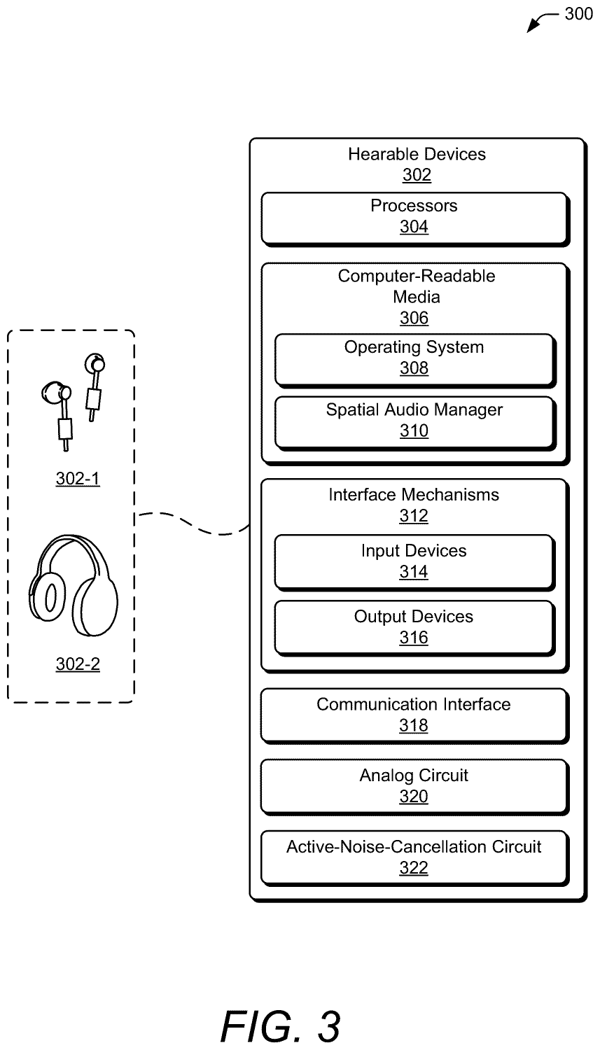

FIG. 3 illustrates an example operating environment 300 including example external devices capable of connecting to electronic devices 202 and having one or more interface mechanisms (e.g., interface mechanisms 220). As described herein, external devices capable of connecting to an electronic device 202 and having at least one speaker are referred to herein as hearable devices 302. Although described herein as being capable of connecting to an electronic device 202, in at least some implementations, a hearable device 302 may be a standalone device having one or more similar components of the electronic device 202 (e.g., the communication system 218) configured to implement some or all features of the electronic device 202 (e.g., wireless communication) without support of an electronic device 202.

As illustrated, non-limiting examples of hearable devices 302 include wired earbuds 302-1 and wireless headphones 302-2. The wired earbuds 302-1 are a type of in-ear device that fits into an auditory canal (e.g., ear canal). In some implementations, each earbud 302-1 can represent a hearable device 302. Wireless headphones 302-2 can rest on top of or over ears. In some implementations, each headphone 302-2 can include two hearable devices 302, which are physically packaged together. In general, there is one hearable device 302 for each ear, but the headphone 302-2 may be referred to as a single hearable device 302-2 for simplicity. Although not shown, the hearable device 302 may also be implemented as any of wireless earbuds, wired headphones, a mobile speaker, and so on. A user may position a hearable device 302 in a manner that creates at least a partial seal around or in the ear (e.g., the ear canal).

Further illustrated, hearable devices 302 may include one or more processors 304 and computer-readable media 306 similar to electronic device 202. The processors 304 may be configured to execute instructions or commands stored within computer-readable media 306. The computer-readable media 306 can include an operating system 308 and a spatial audio manager 310.

The hearable devices 302 may also include one or more interface mechanisms 312. The hearable device 302 may include the one or more interface mechanisms 312 in addition to, or in lieu of, interface mechanisms 220 of a connected electronic device 202. The one or more interface mechanisms 312 of a hearable device 302 may be similar to the one or more interface mechanisms 220 of the electronic device 202. In some implementations, the one or more interface mechanisms 312 include input devices 314 such as a compass, a GPS, an accelerometer, a gyroscope, and/or a microphone. The input devices 314 are configured to receive, measure, and/or generate device data related to conditions, events, and/or qualities associated with a hearable device 302. In additional implementations, the one or more interface mechanisms 312 include output devices 316 such as a speaker.

A speaker and a microphone may be implemented as a transducer, such as a monostatic transducer or a bistatic transducer, configured to convert electrical signals into sound waves and convert sounds waves into electrical signals, respectively. In an example implementation, the transducer has a monostatic topology. With this topology, the transducer can convert the electrical signals into sound waves and convert sound waves into electrical signals (e.g., can transmit or receive acoustic signals). Example monostatic transducers may include piezoelectric transducers, capacitive transducers, and micro-machined ultrasonic transducers (MUTs) that use microelectromechanical systems (MEMS) technology.

Alternatively, the transducer can be implemented with a bistatic topology, which includes multiple transducers that are physically separate. In this case, a first transducer converts the electrical signal into sound waves (e.g., transmits acoustic signals), and a second transducer converts sound waves into an electrical signal (e.g., receives the acoustic signals). An example bistatic topology can be implemented using at least one speaker and at least one microphone.

In general, a speaker is oriented towards the ear canal. Accordingly, the speaker can direct sound waves towards the ear canal. The microphone may be oriented towards, or on a side of the hearable device nearest, a mouth of a user.

The hearable device 302 may further include a communication interface 318 to communicate with an electronic device 202, though this need not be used when the hearable device 302 is integrated within the electronic device 202. The communication interface 318 can be a wired interface or a wireless interface, in which audio content (e.g., an audio message) is passed from the electronic device 202 to the hearable device 302. The hearable device 302 can also use the communication interface 318 to transmit device data received or measured by the input devices 314 to the electronic device 202. In general, the device data provided by the communication interface 318 is in a format usable by a spatial audio manager (e.g., spatial audio manager 214, spatial audio manager 310) of an electronic device 202 or a hearable device 302. The communication interface 318 may also enable the hearable device 302 to communicate with another hearable device 302, such as earbud to earbud.

The hearable device 302 includes at least one analog circuit 320, which includes circuitry and logic for conditioning electrical signals in an analog domain. The analog circuit 320 can include analog-to-digital converters, digital-to-analog converters, amplifiers, filters, mixers, and switches for generating and modifying electrical signals. In some implementations, the analog circuit 320 includes other hardware circuitry associated with a speaker or a microphone.

Some hearable devices 302 include an active-noise-cancellation circuit 322, which enables the hearable device 302 to reduce background or environmental noise. In this case, a microphone can be implemented using a feedback microphone of the active-noise-cancellation circuit 322. During active noise cancellation, the feedback microphone provides feedback information regarding the performance of the active noise cancellation.

The active-noise-cancellation circuit 322 can also include a filter, which attenuates low frequencies to suppress body motion artifacts or wind noise for active noise cancellation. This filter can be selectively disabled or bypassed by the operating system 308. Further, the active-noise cancellation circuit 322 can be enabled or disabled based on a user's election.

### Spatial Audio Manager

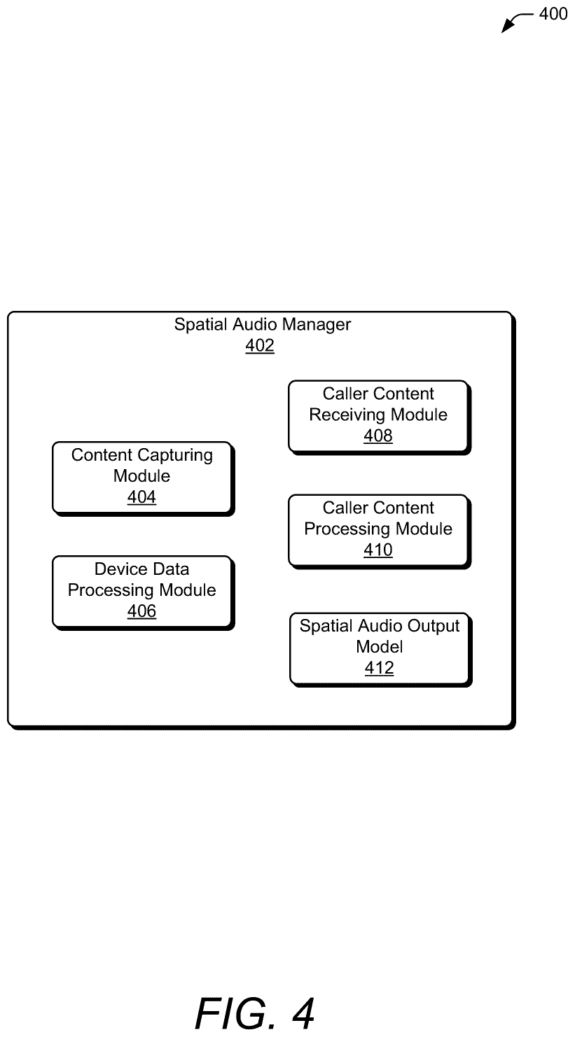

FIG. 4 illustrates an example implementation 400 of a spatial audio manager 402, referred to in FIGS. 2 and 3, in more detail. Although FIG. 4 shows various entities and components as part of the spatial audio manager 402, any of these entities and components may be separate from the spatial audio manager 402 such that the spatial audio manager 402 accesses and/or communicates with them to implement three-dimensional, direction-dependent audio for multi-entity telecommunication in electronic devices 202 and/or hearable devices 302. Further, one or more of these entities and components may be combined, duplicated, and/or divided and still implement three-dimensional, direction-dependent audio for multi-entity telecommunication.

In FIG. 4, the spatial audio manager 402 may include a content capturing module 404 configured to capture (e.g., extract, receive) device data, including sensed data from input devices (e.g., input devices 222, input devices 314), telephone numbers, user data, account data, and so on. For example, the spatial audio manager 402 implemented in a smartphone (e.g., smartphone 202-1) can capture radar data generated by a radar sensor to determine a pose, a rotation of a head of a user, and/or a proximity of the user to the smartphone. In another example, the spatial audio manager 402 implemented in a hearable device 302 can capture acceleration data generated by an accelerometer to determine a rotation of a head of a user and/or an acceleration of the user. In still another example, the spatial audio manager 402 implemented in a standalone hearable device 302 can capture location data generated by an internal GPS to determine a location of the hearable device 302. The spatial audio manager 402 may utilize the content capturing module 404 to obtain data relating to a first user for (i) transmission to another electronic device of a second user or (ii) to compare data of the first user to data of the second user. For example, the content capturing module 404 may compare location data, elevation data, a head orientation of the first user to a head orientation of the second user, and so on.

The spatial audio manager 402 may also include a device data processing module 406. The device data processing module 406 may process the captured device data and generate (e.g., transform, convert) one or more streams of data. In one example, the device data processing module 406 may capture device data, fuse the device data (e.g., sensor fusion, data fusion), and generate stream(s) of data.

The spatial audio manager 402 can further include a caller content receiving module 408. The caller content receiving module 408 is configured to receive one or more streams of data originating from another electronic device (e.g., electronic device 202) or a server (e.g., a cloud-based system). The one or more streams of data may include device data associated with, or relating to, the other electronic device. For example, the caller content receiving module 408 can operate in conjunction with a communication system (e.g., communication system 218) that receives multi-stream content (e.g., multi-stream audio) to extract one or more streams of data from the multi-stream content.

As described herein, multi-stream content can include audio data, device data, video data, and other such data that is transmitted from one or more sources, including an electronic device and/or a server, usable to reproduce at least an audio message. Unless context dictates otherwise, multi-stream content is not to be understood as multi-stream audio, for, in some implementations, multi-stream content may include only one audio stream. Further, multi-stream content is to be understood as having, at minimum, one stream of data, but can include more than one stream of data such as audio data, video data, device data, and so on. In addition, audio data may include single-stream or multi-stream audio.

A caller content processing module 410 can then obtain the extracted one or more streams of data and process the data. In some implementations, the data may include fused data associated with another electronic device. Processing the data may include converting, parsing, classifying, and/or manipulating the data to be in a format usable to a spatial audio output model 412. For example, the caller content processing module 410 can extract GPS coordinates (e.g., longitude, latitude) from the one or more streams of data and may process the GPS data to be in a format usable for the spatial audio output model 412. In another example, the caller content processing module 410 can extract acceleration data, as well as data from a radar sensor or an orientation sensor (e.g., a multi-axis gyroscope) to determine a yaw, pitch, and/or roll of an electronic device or a hearable device and may process the acceleration data, the radar data, and orientation data to be in a format usable for the spatial audio output model 412. In a still further example, the caller content processing module 410 can extract compass data to determine a direction (e.g., a current heading) of an electronic device or a hearable device and may process the compass data to be in a format usable for the spatial audio output model 412.

The spatial audio output model 412 may be configured to receive the processed data, analyze (e.g., compare) the processed data against device data of another electronic device, and reproduce an audio message (e.g., received in the multi-stream content) with a spatial audio effect. For example, analysis of the processed data against device data of another electronic device can include, as non-limiting examples, comparing geographic coordinates, comparing elevations, comparing accelerations, comparing velocities, comparing directions of travel, determining an orientation (e.g., yaw, roll, tilt) of a face of a first user with respect to location coordinates and/or an orientation of a face of a second user, and so forth. In implementations, any combination of the aforementioned comparisons may result in the determination of a vector, which is direction-dependent and includes a magnitude. For example, a vector origin point may start at a first geographic coordinate (e.g., of a transmitting user) and the vector arrow point may end a second geographic coordinate (e.g., of a receiving user).

In an implementation, the spatial audio output model 412 may be implemented as a standard neural-network-based model with corresponding layers required for processing input features. The ML model may be implemented as one or more of a support vector machine (SVM), a recurrent neural network (RNN), a convolutional neural network (CNN), a dense neural network (DNN), one or more heuristics, other machine-learning techniques, a combination thereof, and so forth. For example, the spatial audio output model 412 may be iteratively trained, off-device, to receive processed data based on, as non-limiting examples, location data (e.g., from a GPS), elevation data (e.g., from a barometer), acceleration data (e.g., from an accelerometer), and/or orientation data (e.g., from a compass, from a gyroscope), analyze the processed data against device data of another electronic device, and manipulate an audio message to include a spatial audio effect based on the analysis. Manipulating the audio message to include a spatial audio effect may involve directional audio coding, spatial filtering, directional audio filtering, frequency adjusting, and so forth. Through such training, the machine-learned model can reproduce an audio message having a spatial audio effect.

Although the spatial audio output model 412 is described as implementing a machine-learned technique, in other implementations the spatial audio manager 402 may utilize any number of heuristics or algorithms without machine-learned techniques to implement spatial audio. For example, the spatial audio output model 412 may be an algorithm configured to map a geographic location associated with a source of the multi-stream content to a location in auditory space discernible to a user of an electronic device or hearable device in order to replicate directional hearing.

In at least some implementations, the spatial audio manager 402 is configured to transmit one or more streams of data, including the audio message with the spatial audio effect. For example, the spatial audio manager 402 implemented in an electronic device can transmit multi-stream audio of the audio message with the spatial audio effect to one or more hearable devices.

In aspects, one or more processors (e.g., processors 206, processors 304) may execute the spatial audio manager 402 during telecommunications, such as a phone call, video call, and so on. Entities and components of the spatial audio manager 402 may be executed at different times or in parallel to each other. For example, processors in a first electronic device may, in real-time during telecommunications with a second electronic device, execute the content capturing module 404 and the device data processing module 406 while a first user of the first electronic device is speaking. Then, while a second user of the second electronic device is speaking, the processors in the first electronic device may execute the caller content receiving module 408, the caller content processing module 410, and the spatial audio output model 412. In another example, processors in the first electronic device may execute the content capturing module 404, the device data processing module 406, the caller content receiving module 408, and the caller content processing module 410 at all times during telecommunication. Only while a second user is speaking and an audio message is received by a communication system of an electronic device may processors in the electronic device execute the spatial audio output model 412.

### Example Implementations

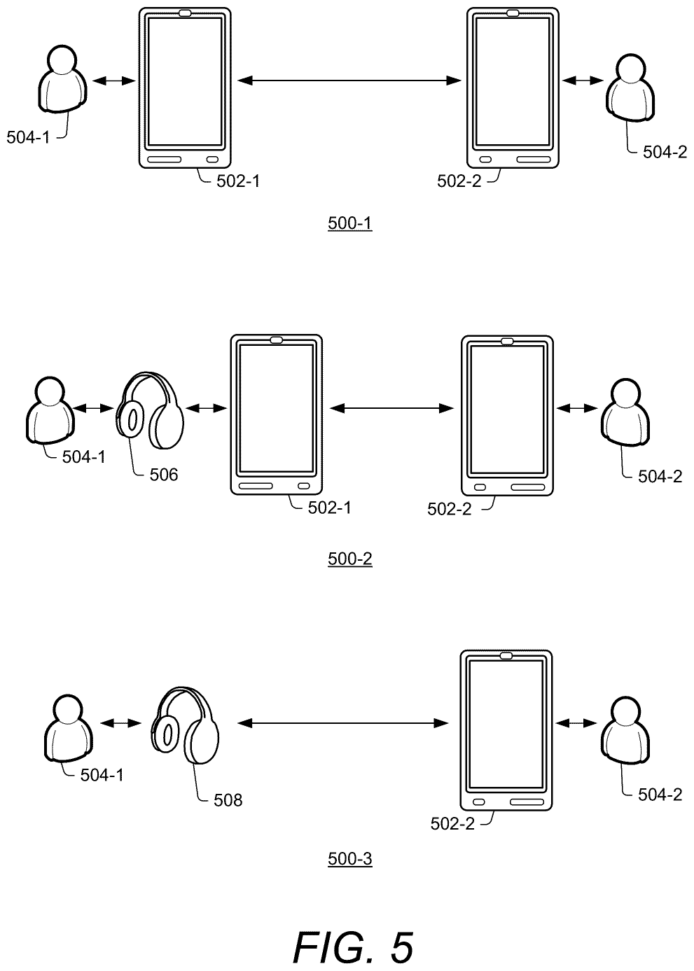

FIG. 5 illustrates three example implementations 500-1, 500-2, and 500-3 in which three-dimensional, direction-dependent audio for multi-entity telecommunication can be implemented. As illustrated in example implementation 500-1, a first electronic device 502-1 associated with a first user 504-1 is in wireless communication with a second electronic device 502-2 associated with a second user 504-2. One or more electronic devices 502 may store the spatial audio manager 402 in computer-readable media 208 such that, during inter-device telecommunication, processors of at least one electronic device 502 having the spatial audio manager 402 may implement spatial audio while reproducing or transmitting an audio message.

In one example, both the first electronic device 502-1 and the second electronic device 502-2 include the spatial audio manager 402. In such a scenario, while the second user 504-2 is speaking and the second electronic device 502-2 transmits multi-stream content directly to the first electronic device 502-1 via their respective communication systems (e.g., communication system 218), the spatial audio manager 402 of the first electronic device 502-1 may be configured to extract at least one stream of data from the multi-stream content. The spatial audio manager 402 may then process the at least one stream of data to determine a location, an elevation, a direction of travel of the second electronic device 502-2, and/or a physical orientation (e.g., gaze direction, nose-pointing direction, chest-facing direction) of the user 504-2. The spatial audio manager 402 can then reproduce an audio message, as contained in the multi-stream content, with a spatial audio effect to enable the user 504-1 to intuit at least a location of the user 504-2 relative to a nose-pointing direction of the user 504-1. Then while the first user 504-1 is speaking and the first electronic device 502-1 transmits multi-stream content directly to the second electronic device 502-2 via their respective communication systems, the spatial audio manager 402 of the second electronic device 502-2 may be configured to extract at least one stream of data from multi-stream content. The spatial audio manager 402 may then process the stream of data to determine a location, an elevation, a direction of travel of the first electronic device 502-1, and/or a physical orientation of the user 504-1. The spatial audio manager 402 can then reproduce an audio message, as contained in the multi-stream content, with a spatial audio effect to enable the user 504-2 to intuit at least a location of the user 504-1 relative to a nose-pointing direction of the user 504-2.

In another example, the first electronic device 502-1 includes the spatial audio manager 402 while the second electronic device 502-2 does not include the spatial audio manager 402. In such a scenario, the spatial audio manager 402 of the first electronic device 502-1 may be configured to extract at least one stream of data from multi-stream content transmitted from the second electronic device 502-2 and received by a communication system of the first electronic device 502-1. Although, in some instances, if the second electronic device 502-2 does not include the spatial audio manager 402, including the content capturing module 404 and the device data processing module 406, then the second electronic device 502-2 may not transmit multi-stream content with data usable to determine information associated with the second electronic device 502-2. If, however, despite not having the spatial audio manager 402, the second electronic device 502-2 transmits multi-stream content with data usable to determine information associated with the second electronic device 502-2, then the spatial audio manager 402 may process the at least one stream of data to determine a location, an elevation, a direction of travel of the second electronic device 502-2, and/or a physical orientation of the user 504-2. In other instances, the first electronic device 502-1 can acquire data usable to determine information associated with the second electronic device 502-2 through other means, such as through angle-based techniques (e.g., estimating a position of an agent by measuring an angle of arrival (AOA) of signals arriving at an antenna), accessing location data of the second electronic device 502-2 via an internet-based application (e.g., a maps application), a local positioning system (LPS), and so on. The spatial audio manager 402 can then reproduce an audio message, as contained in the multi-stream content, with a spatial audio effect to enable the user 504-1 to intuit at least a location of the user 504-2 relative to a nose-pointing direction of the user 504-1.

Example implementation 500-2 illustrates the addition of a hearable device 506 wirelessly connected to the first electronic device 502-1. As illustrated, the hearable device 506 is operatively coupled to the first electronic device 502-1, functioning as an output device (e.g., output device 224) of the first electronic device 502-1. In a first implementation, if the first electronic device 502-1 receives multi-stream content with data usable to determine information associated with a second electronic device 502-2, then the spatial audio manager 402 implemented on the first electronic device 502-1 can, using the hearable device 506, reproduce an audio message with a spatial audio effect to enable the first user 504-1 to intuit at least a direction of the second user 504-2 relative to a nose-pointing direction of the first user 504-1. In a second implementation, if the first electronic device 502-1 receives multi-stream content with data usable to determine information associated with a second electronic device 502-2, then the spatial audio manager 402 implemented on the hearable device 506 can reproduce an audio message with a spatial audio effect. Implementing the spatial audio manager 402 on the hearable device 506 may reduce a potential delay (e.g., lag) in transmitting, processing, and reproducing of the audio message. For example, if the first user 504-1 quickly turns their head, then the spatial audio manager 402 implemented on the hearable device 506 can quickly acquire, using the content capturing model, orientation data, including a roll, tilt and yaw, of the head of the first user 504-1.

Example implementation 500-3 illustrates a hearable device 508 configured to function as a standalone device capable of inter-device telecommunications. As illustrated, the hearable device 508 is implemented as wireless headphones. In such an implementation, the wireless headphones may include one or more components similar to the electronic device 202 of FIG. 2, including the communication system 218. In aspects, the example implementation 500-3 may be substantially similar to the example implementation 500-1.

Although only two electronic devices 502 are illustrated in the implementations illustrated in FIG. 5, in some implementations (not illustrated), three or more electronic devices 502 and/or hearable devices 302 (e.g., hearable device 506, hearable device 508) may be configured to implement three-dimensional, direction-dependent audio for multi-entity telecommunication using any of the aforementioned techniques.

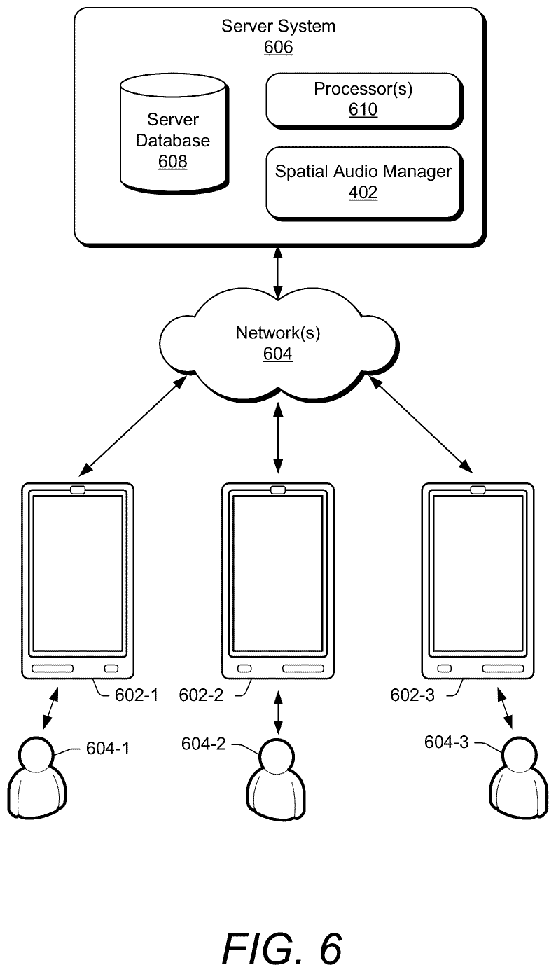

FIG. 6 illustrates an example implementation 600 including three electronic devices 602, network(s) 604, and a server system 606 configured to implement three-dimensional, direction-dependent audio for multi-entity telecommunication. In some implementations, depending on a number of factors including a number of participants in a telecommunication session (e.g., a group call), bandwidth limitations of a network or devices, signal strengths, etc., electronic devices 602 may rely on a server system 606 to implement three-dimensional, direction-dependent audio for multi-entity telecommunication.

The server-client environment shown in FIG. 6 includes a client-side portion (e.g., on electronic devices 602) and a server-side portion (e.g., the server system 606). The division of functionality between the client and server portions of an operating environment can vary in different implementations. Similarly, the division of functionality between an electronic device 602 and the server system 606 can vary in different implementations. Although some aspects of the present technology are described from the perspective of the server system 606, the corresponding actions performed by an electronic device 602 and/or hearable device (e.g., hearable device 506, hearable device 508) would be apparent to one of skill in the art. Similarly, some aspects of the present technology may be described from the perspective of an electronic device 602, and the corresponding actions performed by a server system 606 would be apparent to one of skill in the art. Furthermore, some aspects of the present technology may be performed by the server system 606 and the electronic device 602 cooperatively.

As illustrated, a first electronic device 602-1 associated with a first user 604-1 is in wireless communication with a second electronic device 602-2 associated with a second user 604-2 and a third electronic device 602-3 associated with a third user 604-3. Further illustrated, the server system 606 receives, via network(s) 604 (e.g., a cellular network, an internet network), multi-stream content from one or more of the electronic devices 602. In some implementations, the server system 606 is an audio processing server that provides audio processing services for one or more of the electronic devices 602.

The server system 606 may include a server database 608, processor(s) 610, and the spatial audio manager 402. In one implementation, none of the electronic devices 602 include the spatial audio manager 402. In such a scenario, location data from the electronic devices 502 may be determined through any of a variety of techniques, including cell tower triangulation or accessing location data of the electronic devices 602 via an internet-based application. In another implementation, one or more electronic devices 602 may also include the spatial audio manager 402 and transmit location data in multi-stream content.

In some implementations, the server system 606 is implemented on one or more standalone data processing apparatuses or a distributed network of computers. The server system 606 may also employ various virtual devices and/or services of third-party service providers (e.g., third-party cloud service providers) to provide the underlying computing resources and/or infrastructure resources of the server system 606. In some implementations, the server system 606 includes, but is not limited to, a server computer, a handheld computer, a tablet computer, a laptop computer, a desktop computer, or a combination of any two or more of these data processing devices or other data processing devices.

In some aspects, the multi-stream content includes an audio message from at least one electronic device 602. For example, the multi-stream content can include an audio message from two electronic devices 602. In another example, the multi-stream content can include an audio message and device data from one electronic device 602 and device data from another electronic device 602. The multi-stream content may include one or more streams having respective resolutions and/or rates (e.g., sample rate, frame rate) of raw audio/video captured by input devices (e.g., input devices 222) of the electronic device 602. In some implementations, the multiple streams include a “primary” stream with a certain resolution and rate, corresponding to the raw audio/video captured by the input devices, and one or more additional streams. An additional stream is optionally the same audio/video stream as the “primary” stream but at different resolution and/or rate, or a stream that captures a portion of the “primary” stream at the same or different resolution and/or rate as the “primary” stream.

Further, the server system 606 obtains data usable to determine information associated with any of the first electronic device 602-1, the second electronic device 602-2, and the third electronic device 602-3. Upon obtaining location data associated with at least one electronic device 602, the processor(s) 610 may execute instructions of the spatial audio manager 402 to implement three-dimensional, direction-dependent audio for multi-entity telecommunication. In some implementations, one or more electronic devices 602 transmits multi-stream content to the server system 606 in substantially real-time to manipulate audio messages to include a spatial audio effect. In some implementations, the primary stream and/or the additional streams are dynamically encoded (e.g., based on network conditions, server operating conditions, audio/video source operating conditions, characterization of data in the stream, user preferences, and the like).

In some implementations, the server system 606 transmits multi-stream content, including at least an audio message, to electronic devices 602. Each of the electronic devices 602 may reproduce the audio message with a unique spatial audio effect based on a respective device data (e.g., location) relative to the source device data of the audio message.

### Example Operations

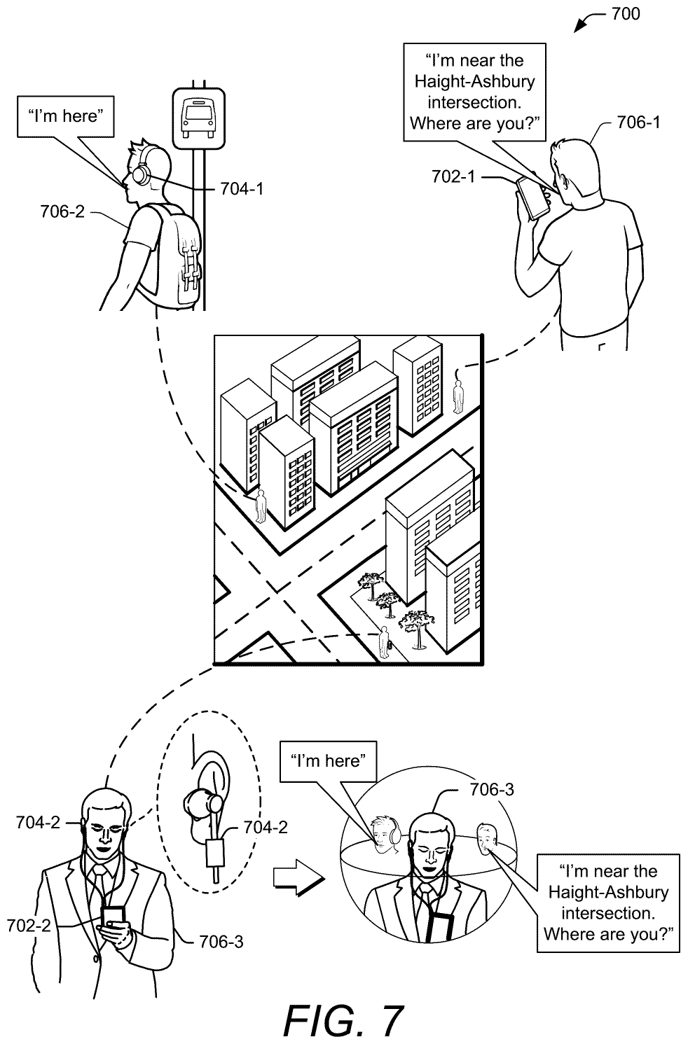

FIG. 7 is an illustration of an example environment 700 in which techniques enabling and apparatuses configured for three-dimensional, direction-dependent audio for multi-entity telecommunication may be embodied. Environment 700 illustrates two example electronic devices 702 (e.g., first electronic device 702-1, second electronic device 702-2) and two hearable devices 704 (e.g., first hearable device 704-1, second hearable device 704-2) configured to implement three-dimensional, direction-dependent audio for multi-entity telecommunication. The first hearable device 704-1 may be implemented as a standalone device having one or more similar components of the electronic devices 702 (e.g., the communication system 218) and may be configured to implement some or all features of the electronic devices 702 (e.g., wireless communication) without support of an electronic device 702. The second hearable device 704-2 may be operatively coupled to the second electronic device 702-2 and may be configured to function as an interface mechanism (e.g., speaker, microphone) in lieu of, or in addition to, integrated interface mechanisms within the second electronic device 702-2.

The electronic devices 702 and the hearable devices 704 can include multiple interface mechanisms (e.g., interface mechanisms 220). For example, the hearable device 704-1 includes input devices 314 such as a compass, a GPS, an accelerometer, a gyroscope, and a microphone. Any of the electronic devices 702 and the hearable devices 704 can be referred to as an audio-producing entity, if the device is configured to transduce a spoken audio message. Further, any of the electronic devices 702 and the hearable devices 704 can be referred to as an audio-receiving entity, if the device is configured to receive multi-stream content via a communication system (e.g., communication system 218).

As illustrated, three users 706 (e.g., first user 706-1, second user 706-2, third user 706-3) may communicate (e.g., speak) to each other in substantially real-time via a communication system of their respective device. In aspects, FIG. 7 illustrates techniques of the spatial audio manager from the perspective of the third user 706-3.

As an example, the first user 706-1 speaks a first audio message to the second user 706-2 and the third user 706-3 via the first electronic device 702-1. Concurrently, or after the first user 706-1 finishes speaking, the second user 706-2 speaks a second audio message to the first user 706-1 and the third user 706-3.

In more detail, the first electronic device 702-1, using a microphone, transduces the audio message spoken by the user 706-1. The first electronic device 702-1 then transmits multi-stream content which includes at least a stream of audio data (e.g., a mono-audio stream) including, and/or relating to, the audio message. In some implementations, the first electronic device 702-1 includes a spatial audio manager (e.g., spatial audio manager 402) which is configured to include device data in the multi-stream content. In additional implementations, the first electronic device 702-1 transmits the multi-stream content, via a network (e.g., network 604), to a server (e.g., server system 606, a cloud-based application). In further implementations, the audio-receiving entity, which depending on an implementation may be an electronic device 702, a hearable device 704, and/or a server (not illustrated), may obtain device data (e.g., orientation data) relating to the device that transmitted the multi-stream content via additional manners, such as web-based applications, triangulation, and so forth.

Similar to first electronic device 702-1, the first hearable device 704-1, using a microphone, transduces the audio message spoken by the user 706-2. The first hearable device 704-1 then transmits multi-stream content, which includes at least a stream of audio data including, and/or relating to, the audio message. In some implementations, the first hearable device 704-1 includes a spatial audio manager, which is configured to include device data in the multi-steam content. In additional implementations, the first hearable device 704-1 transmits the multi-stream content, via a network, to a server. In further implementations, the audio-receiving entity, which depending on an implementation may be an electronic device 702, a hearable device 704, and/or a server (not illustrated), may obtain device data relating to the device that transmitted the multi-stream content via additional manners, such as web-based applications, triangulation, and so forth.

In one implementation, if the audio-receiving entity is a server, then the server receives the transmitted multi-stream content from the first electronic device 702-1 and the first hearable device 704-1. For example, the server can receive multi-steam audio, including a mono-audio stream containing first audio data from the first electronic device 702-1 and a mono-audio stream containing second audio data from the first hearable device 704-1. The server can also obtain device data associated with the second electronic device 702-2 and/or the second hearable device 704-2. In a first implementation, depending on a number of participants, a proximity of the users, and/or the capabilities (e.g., processing power, processing speeds, the inclusion of the spatial audio manager, battery levels, wireless data bandwidth) of one or more devices, the server, using a spatial audio manager, may audibly manipulate the first audio data and the second audio data to include a spatial audio effect (e.g., three-dimensional, direction-dependent audio) based on factors (e.g., locations, head rotation) associated with each of the three users 706. In a second implementation, the server may transmit the multi-stream content and, optionally, obtained device data to the second electronic device 702-2 such that the spatial audio manager included thereon can audibly manipulate the first audio data and the second audio data to include a spatial audio effect.

In another implementation, if the audio-receiving entity is the second electronic device 702-2, then the second electronic device 702-2 receives the transmitted multi-stream content from the first electronic device 702-1 and the first hearable device 704-1. For example, the second electronic device 702-2 can receive multi-steam audio, including a mono-audio stream containing first audio data from the first electronic device 702-1 and a mono-audio stream containing second audio data from the first hearable device 704-1. The second electronic device 702-2 can also obtain device data associated with the second electronic device 702-2 and/or the second hearable device 704-2. For example, using an angle-of-arrival (AOA) of received multi-stream content, the second electronic device 702-2 may be capable of determining a direction from which the multi-stream content originated. Further, a spatial audio manager implemented on the second electronic device 702-2 may obtain device data associated with the second electronic device 702-2. The spatial audio manager may then audibly manipulate the first audio data and the second audio data to include a spatial audio effect (e.g., three-dimensional, direction-dependent audio) based on factors (e.g., locations, head rotation) associated with each of the three users 706.

In additional implementations, the multi-stream content may include additional data, such as video data and/or device data. In such an implementation, the spatial audio manager may be capable of, first, extracting the additional data using, for example, a caller content receiving module. Second, the spatial audio manager may be capable of, optionally, processing the additional data using, for example, the caller content processing module. The spatial audio output model may then be configured to receive the processed data and analyze the processed data against device data of the second electronic device 702-2. For example, a spatial audio output model (e.g., spatial audio output model 412) can obtain geographic coordinates of the user 706-1 transmitted in the multi-stream content and compare the geographic coordinates of the user 706-1 to geographic coordinates of user 706-3. In another example, the spatial audio output model can obtain data indicative of an elevation (e.g., barometric pressure) of the user 706-1 transmitted in the multi-stream content and compare the data indicative of the elevation of the user 706-1 to data indicative of an elevation of user 706-3. In a further example, the spatial audio output model can obtain a face orientation (e.g., yaw, roll, tilt) and a face acceleration and/or velocity of the user 706-1 transmitted in the multi-stream content and compare the face orientation and the face acceleration and/or velocity of the user 706-1 to a face orientation and a face acceleration and/or velocity of user 706-3. In a still further example, the spatial audio output model can obtain a chest-facing direction and a body acceleration and/or velocity of the user 706-1 transmitted in the multi-stream content and compare the chest-facing direction and a body acceleration and/or velocity of the user 706-1 to a chest-facing direction and a body acceleration and/or velocity of user 706-3.

In additional or alternative implementations, the spatial audio manager can obtain data usable to determine information associated with any of the devices, including location data from additional sources. For example, the spatial audio manager may determine location data of the first hearable device 704-1 using cell tower triangulation, accessing location data of the first hearable device 704-1 via an internet-based application, angle-based techniques of received signals, an LPS, and so forth.

Further illustrated in FIG. 7, the spatial audio manager audibly manipulating the first and second audio messages to include a spatial audio effect may involve the spatial audio manager causing a speaker (e.g., a multi-stereo audio output device) associated with the audio-receiving device to reproduce the first and second audio messages in such a fashion that the user 706-3 hears the first and second audio messages as emanating from directions and/or elevations consistent with a location of the first user 706-1 and the second user 706-2, respectively, relative to a nose-pointing direction of the third user 706-3. Further, the spatial audio manager (e.g., spatial audio manager 402) may adjust a volume of the first and second audio messages based on a proximity of the first user 706-1 and the second user 706-2, respectively, to the third user 706-3 (e.g., the first user 706-1 depicted as smaller than the second user 706-2). For example, if the second user 706-2 is closer in proximity to the third user 706-3 than the first user 706-1, then the volume of the second audio message may be greater than the first audio message. In another example, if the third user 706-3 travels in a direction that reduces a proximity to another user, then the spatial audio manager may decrease a volume of an audio message from the other user. Whereas, if the third user 706-3 travels in a direction that increases a proximity to another user, then the spatial audio manager may increase a volume of an audio message from the other user.

Further illustrated in FIG. 7, the first and second audio messages may be reproduced in such a fashion that is consistent with a rotation of a head of the first user 706-1 and the second user 706-2, respectively. For example, the second user 706-2 is depicted as having a head rotation that is perpendicular to a head rotation of the third user 706-3. As a result, the spatial audio manager audibly manipulates the second audio data to cause the speakers to reproduce the second audio message with, for example, an inter-aural frequency difference to imitate an effect of hearing sound from second user 706-2 with the perpendicular head rotation.

In more detail, the spatial audio manager can manipulate the audio message to include a spatial audio effect to alter a user's perception or localization of sound. For example, the spatial audio manager can manipulate an audio message, based on a comparison of device data, to modify (e.g., adjust) an inter-aural time difference, an inter-aural level difference, and/or a timbre difference.

In further implementations, the spatial audio manager can, using one or more input devices (e.g., input devices 222) such as a radar sensor and/or an image capture device, determine an environment surrounding the user 706-2. Additionally, or alternatively, the spatial audio manager can determine an environment surrounding the user 706-2 using location data and/or accessing internet-based services. Based on determining an environment surrounding the user 706-2, the spatial audio manager can reproduce the audio message as emanating from a first direction, to navigate the user 706-2 around a first obstacle (e.g., a building), and then reproduce the audio message as emanating from a second direction (e.g., a direction perpendicular to the first direction) once the user 706-2 navigates around the first obstacle. Further, the spatial audio manager may determine risky obstacles, including streets, rivers, ravines, hills, and so forth, that may or may not be navigable by the user 706-2 and in a direction of travel (e.g., as the crow flies) between the two users 706, but may be more difficult to traverse than another direction of travel. As a result, the spatial audio manager may be capable of reproducing the audio message in such a fashion that it directs the user 706-2 around such risky obstacles.

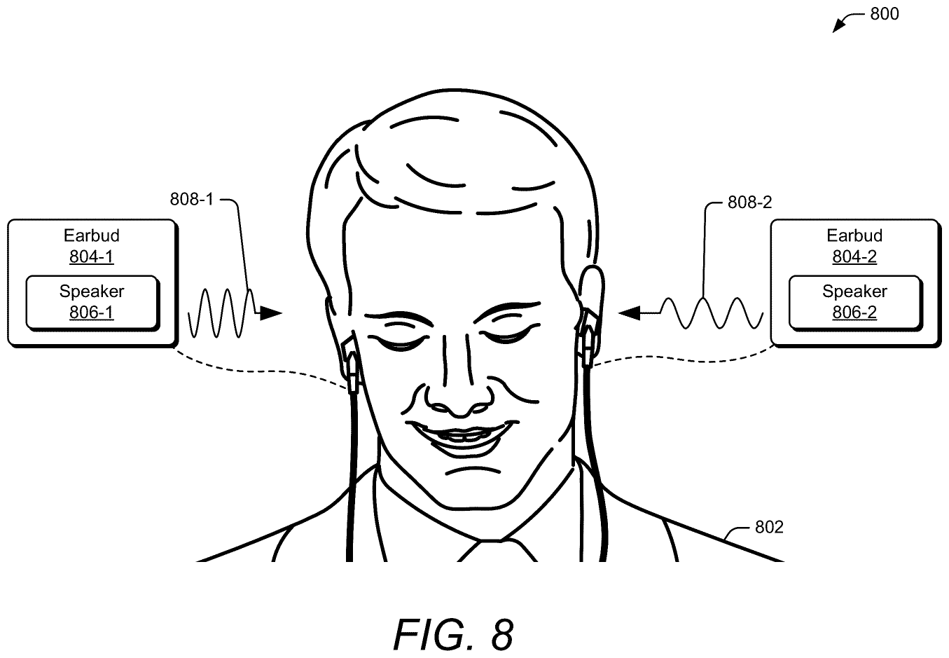

FIG. 8 illustrates an example technique 800 by which the spatial audio manager (e.g., spatial audio manager 402) may manipulate an audio message to include a spatial audio effect. As illustrated, a user 802 is wearing a hearable device (e.g., hearable device 302) with two earbuds 804 (e.g., earbud 804-1, earbud 804-2) that includes a wired connection to an electronic device (not illustrated). In other implementations, the hearable device may be implemented as being wirelessly connected to the electronic device. In additional implementations, a hearable device implemented as a standalone device capable of inter-device telecommunication and including the spatial audio manager can be utilized.

Due to the manipulation and the resultant interpretation of the audio message with the spatial audio effect, the user 802 can not only interpret the soundwaves to, for example, determine words but the user 802 can also subconsciously extract additional information to intuit a direction and/or a magnitude of the audio message. In this way, three-dimensional, direction-dependent audio for multi-entity telecommunication can enable users to intuit additional information in audio messages useful in geographically locating another user.

The speakers 806 are configured to generate pressure waves upon electrical activation (e.g., receiving an electrical signal) with various frequencies and amplitudes. In aspects, the spatial audio manager, implemented on the electronic device, can utilize the speakers 806 in the earbuds 804 to reproduce an audio message with a spatial audio effect. In one example, the spatial audio manager applying directional audio filters and adjusting frequencies of soundwaves 808 is effective to cause the speakers 806 in the earbuds 804 to reproduce the audio message with a spatial audio effect. As illustrated, a first speaker 806-1 in a first earbud 804-1 may be activated to produce soundwaves with a greater frequency than soundwaves produced by a second speaker 806-2 in a second earbud 804-2. Further, a magnitude of the soundwaves 808-1 (e.g., a volume) produced by the first speaker 806-1 in the first earbud 804-1 may be larger than a magnitude of the soundwaves 808-2 produced by the second speaker 806-2 in the second earbud 804-2. The spatial audio manager may constantly adjust these properties and parameters to produce a spatial audio effect in the audio message.

### Example Method

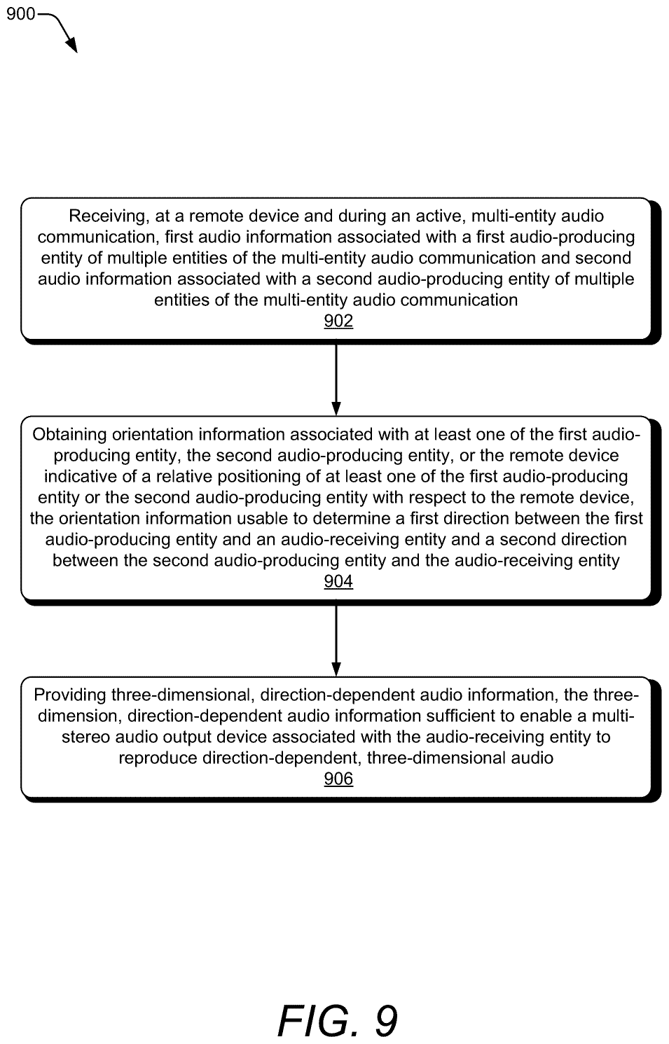

Example method 900 is described with reference to FIG. 9 in accordance with one or more aspects of three-dimensional, direction-dependent audio for multi-entity telecommunication. This method is shown as sets of blocks that specify operations performed but are not necessarily limited to the order or combinations shown for performing the operations by the respective blocks. For example, any number of the described method blocks can be skipped or combined in any order to implement a method or an alternate method. In portions of the following discussion, reference may be made to entities or environments detailed in FIGS. 2-6 and 8 for example only. The techniques are not limited to performance by one entity or multiple entities operating on one device. In one example, one or more operations can be performed at one device, and then remaining operations can be performed at another device.

Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

At 902, the spatial audio manager, implemented at a remote device, including an electronic device (e.g., electronic device 202, hearable device 302) or a server system (e.g., a cloud-based system), can receive multi-entity audio communication, including first audio information associated with a first audio-producing entity (e.g., an electronic device with a microphone) of multiple entities of the multi-entity audio communication and second audio information associated with a second audio-producing entity (e.g., a hearable device with a microphone) of multiple entities of the multi-entity audio communication. For example, the spatial audio manager implemented on a server (e.g., a computing entity associated with a communication network through which the active, multi-entity audio communication is enabled) can receive multi-stream content, including at least audio information, from the first audio-producing entity and/or the second audio-producing entity.

At 904, the spatial audio manager can obtain orientation information associated with at least one of the first audio-producing entity, the second audio-producing entity, or the remote device indicative of a relative positioning of at least one of the first audio-producing entity or the second audio-producing entity with respect to the remote device. The orientation information may be usable to determine a first direction between the first audio-producing entity and an audio-receiving entity and a second direction between the second audio-producing entity and the audio-receiving entity. For example, the spatial audio manager (e.g., spatial audio manager 402) implemented on the server can obtain orientation information associated with the first audio-producing entity and the second audio-producing entity. The server can also obtain orientation information associated with an audio-receiving entity having a multi-stereo audio output device (e.g., an electronic device with integrated, wired, or wirelessly-connected speakers). The multi-stereo audio output device may be implemented as any device, including wireless headphones, having two or more speakers configured to reproduce audio such that sound can be perceived by a user as coming from one or more sources or in different directions. In some implementations, the remote device may be implemented as the first or second audio-producing entity, the audio-receiving entity, a combination thereof, or an altogether separate device. The orientation information may include a roll, pitch, and yaw, as well as location data. The spatial audio manager may obtain the orientation information, and may optionally manipulate the orientation information to be, in a format usable to determine a location, a direction, an elevation, and/or a rotation with respect to the remote device, or the audio-receiving entity.

At 906, the spatial audio manager provides three-dimensional, direction-dependent audio information. The three-dimensional, direction-dependent audio information may be sufficient to enable a multi-stereo audio output device associated with the audio-receiving entity to reproduce direction-dependent, three-dimensional audio. Provision of the three-dimensional, direction-dependent audio information may include a wired transmission or a wireless transmission.

In addition to the above descriptions, the techniques and apparatuses as described herein further enable a user receiving an audio message (a “recipient”) to intuit whether a user providing the audio message (a “speaker”) is directing the audio message to the recipient. For example, while in a restaurant, a caller speaks an audio message to their electronic device, which wirelessly transmits the audio message to an electronic device of a recipient. During the course of the conversation, the caller may direct their attention to a waiter and speak to him. Based on a number of factors sensed by the electronic device, including but not limited to a gaze direction, a head orientation, an increase in volume of the speech, a subject change in the speech, a sensed environment surrounding the electronic device, and so forth, the spatial audio manager may implement spatial audio (e.g., direction-dependent audio).

Further to the above descriptions, although one or more examples have been provided herein describing two or more users in geographically close proximity to one another, the systems and techniques herein can also be utilized for long-distance telecommunication. For instance, two or more users may be geographically separated tens, hundreds, or thousands of meters apart and still enjoy features of the spatial-audio manager. In one example, a first user may be located in Seattle, a second user may be located in Mexico City, and a third user may be located in Berlin. Despite the geographic distance between the users, the spatial audio manager can still audibly manipulate an audio message to provide three-dimensional, direction-dependent audio information sufficient to enable a multi-stereo audio output device associated with an audio-receiving entity to reproduce direction-dependent, three-dimensional audio.

### Additional Examples

In the following section, additional examples are provided.
Example 1: A method comprising: receiving, at a remote device and during an active, multi-entity audio communication: first audio information associated with a first audio-producing entity of multiple entities of the multi-entity audio communication; and second audio information associated with a second audio-producing entity of the multiple entities of the multi-entity audio communication: obtaining orientation information associated with at least one of the first audio-producing entity, the second audio-producing entity, or the remote device indicative of a relative positioning of at least one of the first audio-producing entity or the second audio-producing entity with respect to the remote device, the orientation information usable to determine: a first direction between the first audio-producing entity and an audio-receiving entity; and a second direction between the second audio-producing entity and the audio-receiving entity; and providing three-dimensional, direction-dependent audio information, the three-dimensional, direction-dependent audio information sufficient to enable a multi-stereo audio output device associated with the audio-receiving entity to reproduce direction-dependent, three-dimensional audio.
Example 2: The method of example 1, wherein the remote device is the multi-stereo audio output device.
Example 3: The method of example 1 or 2, wherein the multi-stereo audio output device is configured to, based on the three-dimensional, direction-dependent audio information, reproduce direction-dependent, three-dimensional audio that includes an audible-manipulation of at least one of the first audio information or the second audio information based on the orientation information of one or more of the multi-stereo audio output device, the first audio-producing device, and the second audio-producing device.
Example 4: The method of example 3, wherein the audible-manipulation includes a machine-learned technique configured to adjust at least one of an inter-aural time difference, an inter-aural level difference, or a timbre difference.
Example 5: The method of any previous example, wherein the multi-stereo audio output device includes one or more of a smartphone, wireless earbuds, and wired headphones.
Example 6: The method of example 1, wherein the remote device is a computing entity associated with a communication network through which the active, multi-entity audio communication is enabled.
Example 7: The method of example 6, further comprising determining, based on a capability or configuration of the multi-stereo audio output device, that the receiving entity is less capable of providing three-dimensional, direction-dependent audio information, and, based on the capabilities of the multi-stereo audio output device, performing the operations of determining and providing at the computing entity.
Example 8: The method of example 1, wherein receiving multi-entity audio communication and obtaining orientation information occur in substantially real-time concurrently.
Example 9: The method of example 8, wherein the first audio information and orientation information associated with the first audio-producing entity are transmitted together in multi-stream data from the first audio-producing entity.
Example 10: The method of example 1, wherein obtaining orientation information associated with at least the first audio-producing entity, the second audio-producing entity, or the remote device comprises acquiring location information associated therewith based on a location-based application.
Example 11: The method of example 1, wherein the orientation information is further usable to determine: a first rotation of the first audio-producing entity with respect to a relative rotation of the remote device; and a second rotation of the second audio-producing entity with respect to the relative rotation of the remote device.
Example 12: The method of any previous example, wherein the orientation information includes an orientation of a user's head or ears or an orientation of one or more speakers or exterior housing of the first audio-producing entity, the second audio-producing, or the remote device.
Example 13: The method of any previous example, wherein the first rotation or the second rotation of the first audio-producing entity or the second audio-producing entity, respectively, with respect to the relative rotation of the remote device, is further usable to determine one or more of a difference in elevation and a proximity between the first audio-producing entity and the remote device or the second audio-producing entity and the remote device.
Example 14: The method of any previous example, further comprising receiving video information, and wherein providing the three-dimensional, direction-dependent audio provides video information enabling a display associated with the multi-stereo audio output device to provide video associated with the first or second audio-producing entity.
Example 15: The method of any previous example, wherein determining the first and second directions further determines a first and second vector, the first and second vector having the first and second directions, respectively, the first and second vectors having respective magnitudes based on an absolute or relative distance between the audio-receiving entity and first and second locations of the location information.

### CONCLUSION

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B.” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying Drawings and terms discussed herein may be indicative of one or more items or terms, and thus reference may be made interchangeably to single or plural forms of the items and terms in this written description.

Although implementations for three-dimensional, direction-dependent audio for multi-entity telecommunication have been described in language specific to certain features and/or methods, the subject of the appended Claims is not necessarily limited to the specific features or methods described. Rather, the specific features and methods are disclosed as example implementations for three-dimensional, direction-dependent audio for multi-entity telecommunication.

1. A method comprising:
receiving, at a remote device and during an active, multi-entity audio communication:
first audio information associated with a first audio-producing entity of multiple entities of the multi-entity audio communication; and
second audio information associated with a second audio-producing entity of the multiple entities of the multi-entity audio communication;
obtaining orientation information associated with at least one of the first audio-producing entity, the second audio-producing entity, or the remote device indicative of a relative positioning of at least one of the first audio-producing entity or the second audio-producing entity with respect to the remote device, the orientation information usable to determine:
a first direction between the first audio-producing entity and an audio-receiving entity; and
a second direction between the second audio-producing entity and the audio-receiving entity; and
providing three-dimensional, direction-dependent audio information, the three-dimensional, direction-dependent audio information sufficient to enable a multi-stereo audio output device associated with the audio-receiving entity to reproduce direction-dependent, three-dimensional audio.

2. The method of claim 1, wherein the remote device is the multi-stereo audio output device.

3. The method of claim 1, wherein the multi-stereo audio output device, using the three-dimensional, direction-dependent audio information, is configured to reproduce direction-dependent, three-dimensional audio that includes an audible-manipulation of at least one of the first audio information or the second audio information based on the orientation information of one or more of the multi-stereo audio output device, the first audio-producing device, and the second audio-producing device.

4. The method of claim 3, wherein the audible-manipulation includes a machine-learned technique configured to adjust at least one of an inter-aural time difference, an inter-aural level difference, or a timbre difference.

5. The method of claim 1, wherein the multi-stereo audio output device includes one or more of a smartphone, wireless earbuds, or wired headphones.

6. The method of claim 1, wherein the remote device is a computing entity associated with a communication network through which the active, multi-entity audio communication is enabled.

7. The method of claim 6, further comprising determining, based on a capability or configuration of the multi-stereo audio output device, that the receiving entity is not capable of providing three-dimensional, direction-dependent audio information, and, responsive to the determining, performing operations of determining and providing at the computing entity.

8. The method of claim 1, wherein receiving multi-entity audio communication and obtaining orientation information occur in real-time and concurrently.

9. The method of claim 8, wherein the first audio information and orientation information associated with the first audio-producing entity are transmitted together in multi-stream data from the first audio-producing entity.

10. The method of claim 1, wherein obtaining orientation information associated with at least the first audio-producing entity, the second audio-producing entity, or the remote device comprises acquiring location information associated therewith based on a location-based application.

11. The method of claim 1, wherein the orientation information is further usable to determine:
a first rotation of the first audio-producing entity with respect to a relative rotation of the remote device; and
a second rotation of the second audio-producing entity with respect to the relative rotation of the remote device.

12. The method of claim 11, wherein the first rotation or the second rotation of the first audio-producing entity or the second audio-producing entity, respectively, with respect to the relative rotation of the remote device is further usable to determine one or more of a difference in elevation and a proximity between the first audio-producing entity and the remote device or the second audio-producing entity and the remote device.

13. The method of claim 1, wherein the orientation information includes an orientation of a user's head or ears or an orientation of one or more speakers or exterior housing of the first audio-producing entity, the second audio-producing, or the remote device.

14. The method of claim 1, further comprising receiving video information, and wherein providing the three-dimensional, direction-dependent audio provides video information enabling a display associated with the multi-stereo audio output device to provide video associated with the first or second audio-producing entity.

15. The method of claim 1, wherein determining the first and second directions further determines first and second vectors, the first and second vectors having the first and second directions, respectively, the first and second vectors having respective magnitudes based on an absolute or relative distance between the audio-receiving entity and first and second locations of the location information, and wherein the providing the three-dimensional audio provides three-dimensional audio with corresponding magnitudes.

16. An electronic device, the electronic device comprising:
one or more processors;
a communication system; and
a computer-readable media storing instructions that, when accessed by the one or more processors, cause the one or more processors to:
receive, over the communication system and during an active, multi-entity audio communication:
first audio information associated with a first audio-producing entity of multiple entities of the multi-entity audio communication; and
second audio information associated with a second audio-producing entity of the multiple entities of the multi-entity audio communication;
obtain orientation information associated with at least one of the first audio-producing entity, the second audio-producing entity, or the electronic device indicative of a relative positioning of at least one of the first audio-producing entity or the second audio-producing entity with respect to the electronic device, the orientation information usable to determine:
a first direction between the first audio-producing entity and an audio-receiving entity; and
a second direction between the second audio-producing entity and the audio-receiving entity; and
providing three-dimensional, direction-dependent audio information, the three-dimensional, direction-dependent audio information sufficient to enable a multi-stereo audio output device associated with the audio-receiving entity to reproduce direction-dependent, three-dimensional audio.

17. The electronic device of claim 16, wherein the electronic device is the multi-stereo audio output device.

18. The electronic device of claim 16, wherein the multi-stereo audio output device, using the three-dimensional, direction-dependent audio information, is configured to reproduce direction-dependent, three-dimensional audio that includes an audible manipulation of at least one of the first audio information or the second audio information based on the orientation information of one or more of the multi-stereo audio output device, the first audio-producing device, and the second audio-producing device.

19. The electronic device of claim 18, wherein the audible manipulation includes a machine-learned technique configured to adjust at least one of an inter-aural time difference, an inter-aural level difference, or a timbre difference.

20. The electronic device of claim 16, wherein the multi-stereo audio output device includes one or more of a smartphone, wireless earbuds, or wired headphones.
